(19) United States
(12) Patent Application Publication
(10) Pub. No.: US 2011/0014844 A1
(43) Pub. Date: Jan. 20, 2011

(54) Modular Play Environment for a Wheeled Object

(75) Inventors: Joshua Henson, Manhattan Beach, CA (US); David Sheltman, Rancho Palos Verdes, CA (US)

Correspondence Address: Edell, Shapiro & Finnan LLC, 1901 Research Blvd, Suite 400, Rockville, MD, 20850, US

(73) Assignee: Mattel, Inc., El Segundo, CA (US)

(21) Appl. No.: 12/768,113

(22) Filed: Apr. 27, 2010

Related U.S. Application Data
(60) Provisional application No. 61/214,777, filed on Jul. 20, 2009.

(51) Int. Cl. A63H 33/04; B23P 17/04

(52) U.S. Cl. 446/85; 29/428

(57) ABSTRACT

A modular, reconfigurable playset or system is disclosed. The system includes several modules or accessories with which wheeled objects, such as miniature skateboards, can be used. At least some of the modules or accessories include a coupling portion that is configured to be engaged with a coupling portion of a different module or accessory. In one embodiment, the modules or accessories are moved laterally toward each other to engage the coupling portions of the modules together.

### CROSS REFERENCE TO RELATED APPLICATION AND CLAIM TO PRIORITY

The present application claims priority to and is based on U.S. provisional application Ser. No. 61/214,777, filed Apr. 27, 2009, titled “Modular Fingerboard Play Environment,” the disclosure of which is incorporated herein by reference in its entirety.

### FIELD OF THE INVENTION

This invention relates generally to fingerboard playsets and particularly to play environments for use therewith.

### BACKGROUND OF THE INVENTION

Practitioners in the art have developed miniature skateboards often called “fingerboards” for use in play activities which mimic the play of participants in full sized skateboard activities. Such fingerboards typically comprise elongated substantially flat thin boards having upwardly curved end portions. The undersurface of the fingerboards supports a pair of front wheels and a pair of rear wheels similarly spaced and proportioned to mimic conventional skateboards. Most fingerboards accommodate a gripping surface material on the upper surface such as sandpaper, emery cloth or rubber grip material. In the typical play pattern the user places the tips of the index and first finger upon the board and manipulates the board across surfaces and obstacles in a rolling and jumping play pattern. Not surprisingly, the popularity of such fingerboards have motivated practitioners in the toy arts to provide suitably scaled play environments having ramps, stairs and railings for play activities.

### SUMMARY OF THE INVENTION

The present invention provides a modular play environment for fingerboard activities having a plurality of apparatus each of which forms a portion of a fingerboard play environment. The modular apparatus are interchangeably joinable by interposed connectors to facilitate the creation of one or more fingerboard environments. The modular elements typically use rolling surfaces or ramp portions which are formed of a composite and wood and plastic material for improved strength and fabrication. Typically, the composite material is formed of wood filler or fine sawdust together with a binder material such as ABS, PVC or epoxy binder materials. The proportion of wood filler material to binder is selected to achieve the desired strength and surface characteristics.

In one embodiment, a reconfigurable assembly for use with a miniature wheeled object includes a first accessory with at least one contact surface for engagement by the wheeled object, the first accessory including a side portion with a coupling portion, and a second accessory with at least one contact surface for engagement by the wheeled object, the second accessory including a side portion with a coupling portion, the coupling portion of the second accessory being engageable with the coupling portion of the first accessory by movement of the second accessory toward the first accessory in a lateral direction.

In one embodiment, the side portion of the first accessory is a first side portion and the first accessory includes a second side portion, the coupling portion of the first accessory is a first coupling portion, and the first accessory includes a second coupling portion, the first coupling portion being located along part of the first side portion and the second coupling portion being located along part of the second side portion.

In one embodiment, the coupling portion of the second accessory can be coupled to either of the first coupling portion or the second coupling portion of the first accessory by lateral movement of the second accessory toward and into engagement with the first accessory.

In one embodiment, the coupling portion of the second accessory includes a coupler removably coupleable with the second accessory, the coupler being engageable with the coupling portion of the first accessory.

In one embodiment, the coupling portion of the first accessory includes a recess and the coupling portion of the second accessory includes a recess, each of the recesses receiving part of the coupler when the coupler is engaged with the coupling portion of the first accessory and the coupling portion of the second accessory.

In one embodiment, the coupler includes a first portion that is laterally insertable into the recess of the coupling portion of the first accessory and a second portion that is laterally insertable into the recess of the coupling portion of the second accessory.

In one embodiment, one contact surface of the first accessory can be positioned proximate to one contact surface of the second accessory when the coupler is engaged with the first accessory and the second accessory.

In one embodiment, one contact surface of the first accessory and one contact surface of the second accessory form a continuous surface when the first accessory and the second accessory are coupled together.

In one embodiment, the second accessory is reconfigurable so that the angle of one contact surface of the second accessory relative to a support surface on which the first accessory can be placed can vary.

In an alternative embodiment, a method of assembling a reconfigurable system for use with a wheeled object includes the steps of disposing a first accessory in a first orientation, the first accessory having an engagement surface that can be engaged by the wheeled object, the first accessory including a coupling portion, disposing a second accessory in a second orientation, the second accessory having an engagement surface that can be engaged by the wheeled object, the second accessory including a coupling portion, and moving the second accessory laterally toward and into engagement with the first accessory, the movement of the second accessory resulting in the engagement of the coupling portion on the second accessory with the coupling portion of the first accessory.

In one embodiment, the coupling portion of the second accessory includes a recess and the coupling portion of the first accessory includes a recess, and the method includes inserting a coupler into the recess of the coupling portion of the second accessory.

In one embodiment, the moving a second accessory includes engaging the coupler with the recess of the first accessory.

In one embodiment, the coupling portion of the first accessory is a first coupling portion and the first accessory includes a second coupling portion, and the method includes decoupling the second accessory from the first accessory, moving the second accessory from its second orientation to a third orientation relative to the first accessory, the third orientation being different from the second orientation, and moving the second accessory laterally into engagement with the first accessory so that the second accessory is maintained in the third orientation relative to the first accessory, the movement resulting in engagement of the coupling portion of the second accessory with the second coupling portion of the first accessory.

In an alternative embodiment, a reconfigurable assembly for use with a wheeled object includes a first engagement accessory having a surface along which the wheeled object can travel, the first engagement accessory having a coupling mechanism with a receiving portion, and a second engagement accessory having a surface along which the wheeled object can travel, the second engagement accessory having a coupling mechanism with a projecting portion that engages the receiving portion when the second engagement accessory is moved laterally toward and into engagement with the first engagement accessory.

In one embodiment, the second engagement accessory has a body, the coupling mechanism of the second engagement accessory includes a recess formed in the body and a removable coupler that can be inserted into the recess of the body, and the coupler includes the projecting portion.

In one embodiment, the coupler is laterally insertable into the recess on the body of the second engagement accessory.

In one embodiment, the first engagement accessory has a body that includes a first side with a first recess and a second side with a second recess, each recess being configured to receive the projecting portion of the coupler.

In one embodiment, the surface of the first engagement accessory can be positioned proximate to the surface of the second engagement accessory when the coupler is engaged with the first engagement accessory and the second engagement accessory.

In one embodiment, the surface of the first engagement accessory and the surface of the second engagement accessory form a continuous surface when the first engagement accessory is coupled to the second engagement accessory.

In one embodiment, the second engagement accessory is reconfigurable so that the angle of the surface of the second engagement accessory relative to a support surface on which the second engagement accessory can be placed can vary.

### BRIEF DESCRIPTION OF THE DRAWINGS

The present invention is shown in the various figures attached hereto in which each element maintains the same reference numeral in the various views shown herein and in which:

FIG. 1 sets forth a perspective view of a modular fingerboard play environment constructed in accordance with the present invention;

FIG. 2 sets forth a top perspective view of the modular fingerboard play environment shown in FIG. 1;

FIG. 3 sets forth a perspective view of the simulated stairway module of the present modular fingerboard play environment invention having a ramp in line with the stair portions;

FIG. 4 sets forth a perspective view of the module of FIG. 3 having a ramp in a sideways orientation;

FIG. 5 sets forth a rear perspective view of the module shown in FIG. 4;

FIG. 6 sets forth a perspective view of the ramp module of the present modular fingerboard play environment invention showing the ramp at its lowest inclination;

FIG. 7 sets forth a perspective view of the ramp module of FIG. 6 having the secondary ramp extending forwardly therefrom;

FIG. 8 sets forth a perspective view of the module of FIG. 6 at its highest angle of inclination;

FIG. 9 sets forth a perspective view of the ramp module of FIG. 6 in its fully collapsed configuration;

FIG. 10 sets forth a perspective view of the picnic table module of the present modular fingerboard play environment invention;

FIG. 11 shows an additional perspective view of the picnic table module shown in FIG. 10;

FIG. 12 sets forth a perspective view of the picnic table module shown in FIG. 10 in its collapsed position;

FIG. 13 sets forth a perspective view of the picnic table module of FIG. 10 in its ramp configuration;

FIG. 14 sets forth a perspective view of the curved ramp and rail module of the present modular fingerboard play environment invention;

FIG. 15 sets forth a perspective view of the dual curved ramp module of the present modular fingerboard play environment invention;

FIG. 16 sets forth a perspective view of a curved ramp module;

FIG. 17 sets forth a perspective front view of the curved ramp module of FIG. 16;

FIG. 18 sets forth a front perspective view of the dual curved ramp module shown in FIG. 15;

FIG. 19 sets forth a front perspective view of the curved ramp and rail module shown in FIG. 14;

FIG. 20 sets forth a front perspective view of a dual ramp and rail module of the present modular fingerboard play environment invention;

FIG. 21 sets forth a side perspective view of the module of FIG. 20;

FIG. 21A sets forth a perspective view of an alternative embodiment of a reconfigurable assembly or system according to the present invention;

FIG. 22 sets forth a partial assembly view of a typical module connector constructed in accordance with the present invention;

FIG. 23 sets forth a side elevation view of the modular connector of the present invention;

FIG. 24 sets forth a perspective assembly view of the module connector shown in FIG. 23;

FIG. 25 sets forth a side elevation view of the coupler utilized in the present modular fingerboard play environment invention;

FIG. 26 sets forth a perspective view of an embodiment of an engagement accessory according to the present invention;

FIG. 27 sets forth another perspective view of the engagement accessory shown in FIG. 26;

FIG. 28 sets forth a perspective view of another embodiment of an engagement accessory in a deployed configuration according to the present invention;

FIG. 29 sets forth a bottom view of the engagement accessory of FIG. 28 in a collapsed configuration;

FIG. 30 sets forth a perspective view of the engagement accessory of FIG. 28 in another deployed configuration;

FIG. 31 sets forth a perspective view of another embodiment of a modular system according to the present invention;

FIG. 32 sets forth a perspective view of the central portion of the system of FIG. 31;

FIG. 33 sets forth a perspective view of an embodiment of a ramp assembly of the system of FIG. 31;

FIG. 34 sets forth a perspective view of an alternative embodiment of a ramp assembly of the system of FIG. 31;

FIG. 35 sets forth a perspective view of the components of the system of FIG. 31 in a different configuration;

FIG. 36 sets forth a bottom perspective view of a component of the ramp assembly of FIG. 34;

FIG. 37 sets forth a perspective view of the components of system of FIG. 31 in a different configuration;

FIG. 38 sets forth a perspective view of a portion of the system of FIG. 31;

FIG. 39 sets forth a side view of the portion of the system of FIG. 38 in a raised configuration; and

FIG. 40 sets forth a side view of the portion of the system of FIG. 38 in a lowered configuration.

### DETAILED DESCRIPTION OF THE INVENTION

By way of overview, the present invention provides a modular fingerboard play environment for use with small miniature fingerboards which is formed by a plurality of interconnectable and interchangeable play modules. The combination of any group of play modules configures a play environment or obstacle course to be traversed by a fingerboard player. The modules are interconnectable in multiple configurations utilizing a novel connecting system which is facilitated by the cooperation of three components. Two cup-like components are formed on or attached to the to-be-mated modules while a coupler element is received between the cups to facilitate the attachment of two modules. Various combinations of modules or accessories form reconfigurable assemblies.

The terms “accessory,” “engagement accessory,” and “module” are used interchangeably herein to refer to one of the components of a modular system that can be manipulated and reconfigured by a user to create different play environments. The term “wheeled object” is used to refer to an object that includes at least one wheel and that can move or be moved by a user along a surface. In some references, the term “miniature” is used with “wheeled object” to indicate that the particular wheeled object is a small version of a larger object usable by a user. For example, a miniature skateboard is a small version of a skateboard that can be ridden by a user. Other examples of wheeled objects include miniature and/or toy vehicles, miniature and/or toy bicycles, and other structures that can be used to move from one place to another.

The terms “engagement surface” and “contact surface” are used interchangeably to refer to a surface along which a wheeled object can move and/or be moved by a user. Also, the terms “play environment,” “assembly,” and “system” are used interchangeably to refer to several of the modules or accessories that can be used together to form one or more structures on which a wheeled object can be used. In the various embodiments described herein, the terms “side frame,” “side,” and “side portion” are used interchangeably to reference part of a module or accessory.

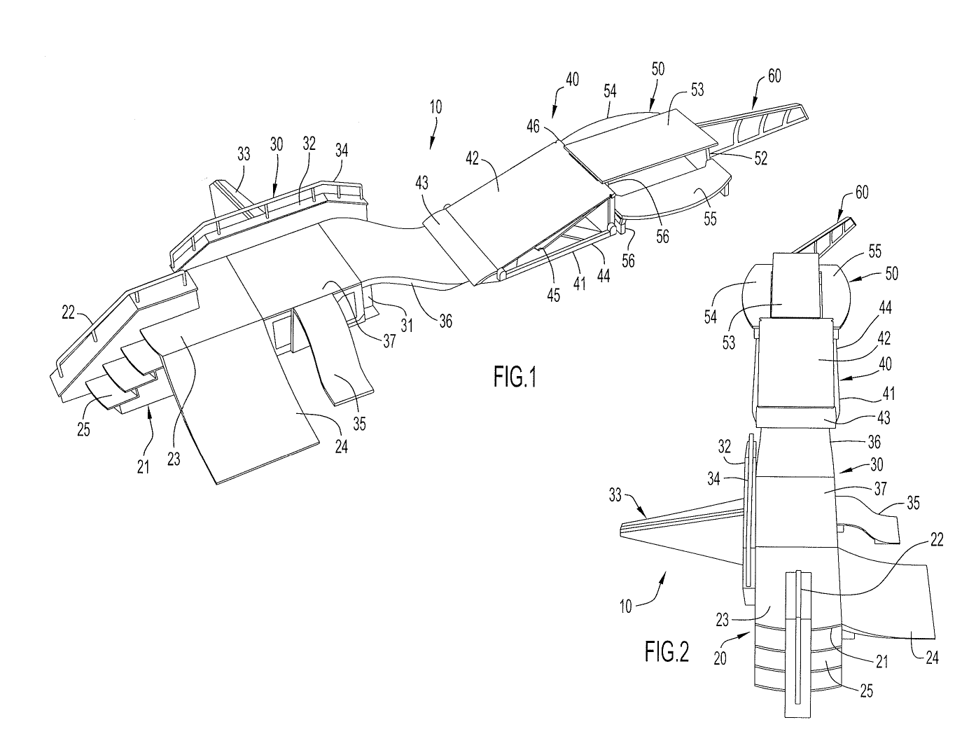

More specifically, FIGS. 1 and 2 set forth perspective views of a modular fingerboard play environment constructed in accordance with the present invention and generally referenced by numeral 10. FIGS. 1 and 2 show different perspective views of modular fingerboard play environment 10 which will be discussed concurrently. Thus, play environment 10 includes a plurality of modules or accessories that are coupled together to form a combined obstacle course and play environment. A stair module 20 includes a base 21 supporting a platform 23 and a curved ramp 24. Stair module 20 further supports a rail 22 and a plurality of steps 25. The various features of the stair module 20 can be engaged by a wheeled object that can simulate tricks and motions performable by a user on a wheeled object.

Play environment 10 further includes a rail module 30 having a side frame 32 and a base 31. Base 31 supports a platform 37 to which a curved ramp 35 is joined. Side frame 32 further supports a rail 34. Rail module 30 further includes a dual curved ramp module 33 joined to side frame 32 in the manner described below. Rail module 30 further includes a curved ramp 36 joined to platform 37.

In this embodiment, play environment 10 further includes a ramp module 40 having a frame 41 and a support 44. Frame 41 and support 44 further include a hinge 46 to which a ramp 45 and a ramp 42 are hingedly joined. Ramp module 40 further includes a plate 43 that is located proximate to ramp 42. Play environment 10 also includes a picnic table module 50 having a pair of frame members 56 and 52 supporting a tabletop 53 and a pair of seats 54 and 55. A connection portion is provided proximate to frame member 56 to couple the picnic table module 50 and the ramp module 40. A rail module 60 is secured to frame 52 and can be used as a lead-in structure for a wheeled object to access the tabletop 53.

In accordance with the present invention, the various rolling elements of play environment 10 are preferably fabricated of a composite material molded in the desired shape. While the chemical constituents used to fabricate the molded composite material utilized in play environment 10 may be varied without departing from the spirit and scope of the present invention, it has been found advantageous to select a wood particulate material such as sawdust or the like to be combined with a binder material such as epoxy, ABS plastic or polyvinyl plastic material. Once again, the proportional relationship between the binder and wood fiber material may be varied in accordance with the characteristics to be obtained. However, it has been found generally satisfactory to utilize approximately thirty percent binder material and seventy percent wood fiber or saw dust material. In the play environment shown in FIG. 1, the preferred fabrication utilizes molded composite material for platform 23, curved ramp 24, platform 37, curved ramp 35, curved ramp 36, ramp 45, ramp 42, tabletop 53, seat 54 and seat 55. As will be described below in greater detail, the various modules shown in play environment 10 may be intercoupled in a different combination or arrangement to provide a still further variation of play environment.

As shown in FIGS. 1-2, the contact or engagement surfaces of adjacent modules can be placed next to each other when the modules are coupled. In addition, the contact surfaces of adjacent modules can form a substantially continuous surface in that one contact surface is aligned with and smoothly transitions to the other contact surface.

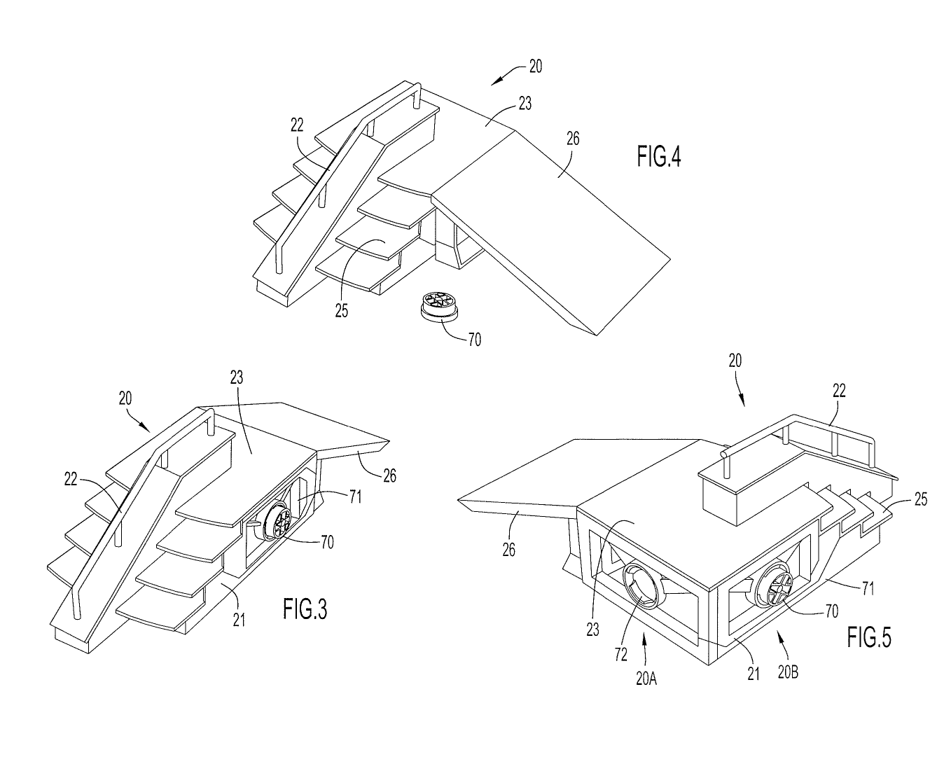

FIGS. 3, 4 and 5 set forth front, side and rear perspective views of stair module 20. With simultaneous reference to FIGS. 3, 4 and 5, stair module 20 includes a base 21 supporting a plurality of steps 25 and a platform 23. Module 20 further includes a rail 22 and a ramp 26. Referring to FIGS. 3 and 4, the ramp 26 may be placed in several positions with respect to platform 23. As shown, the ramp 26 may be coupled to different sides of the base 21 to provide different manners of access to the ramp 26.

As is also seen in FIGS. 3, 4 and 5, base 21 supports a plurality of connectors or coupling portions for use in attaching the stair module 20 to an additional module or modules in the play environment. The coupling portions can be referred to alternatively as a coupling mechanism. Thus, as is seen in FIGS. 3 and 5, base 21 supports a coupling portion 20B that includes a connector cup 71 and a coupler 70 on one side and a coupling portion 20A with a connector cup 72 on the other side. Each connector cup 71 and 72 forms a different coupling portion and defines a recess as shown. Each of the recesses is sized to receive the coupler 70 therein, thereby facilitating the coupling of another module to the stair module 20. The coupler 70 can be inserted into one of the recesses and retained therein until removed by the user. Coupler 70 is configured in the manner described below and is received within a host cup for connector attachment. Referring to FIG. 5, in this embodiment, stair module 20 includes a coupling portion 20A on one side of the stair module 20 and another coupling portion 20B on a different side of the stair module 20. At any one time, the coupling portions 20A and 20B may or may not have a coupler with a projecting portion.

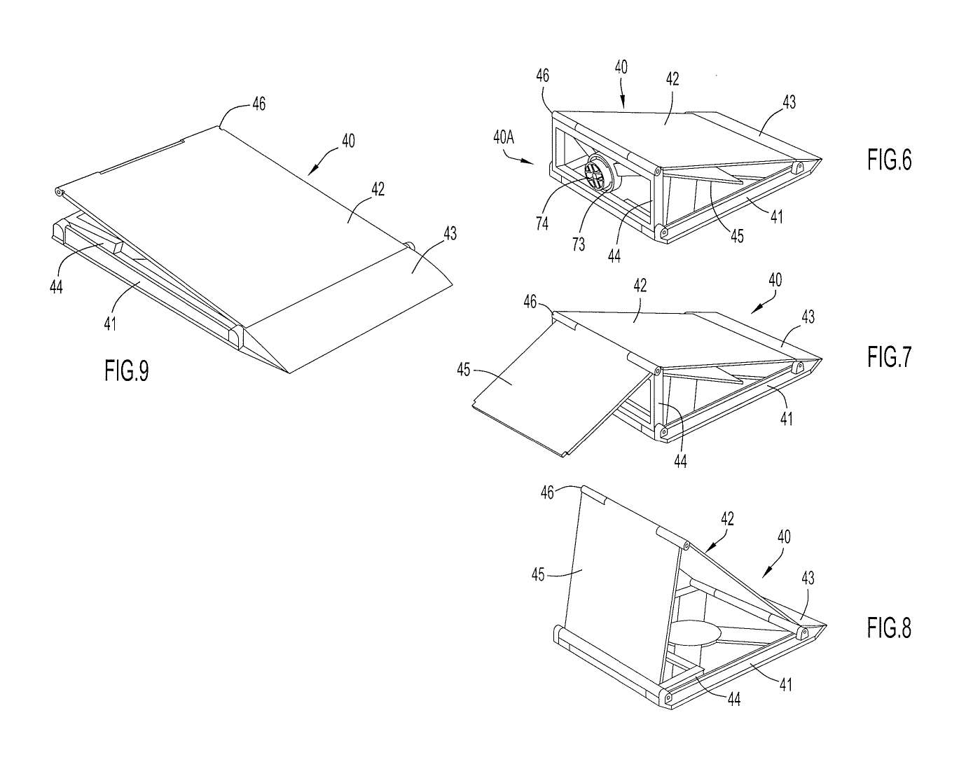

FIGS. 6, 7, 8 and 9 set forth perspective views of ramp module 40 in different configurations. FIG. 6 shows ramp module 40 in a slight incline ramp while FIG. 7 shows module 40 having dual ramps. FIG. 8 shows module 40 in a steeply inclined ramp set while FIG. 9 shows module 40 fully collapsed.

With simultaneous reference to FIGS. 6, 7, 8 and 9, module 40 includes a frame 41 having a vertical support 44 at one end thereof. The upper end of support 44 includes a hinge 46 to which ramps 45 and 42 are joined. Thus, ramps 45 and 42 are hinged in attachment and may be pivoted as is seen in FIGS. 6 through 9. Ramp 42 further supports a plate 43 that can be used for access to ramp 42.

In the configuration shown in FIG. 6, module 40 is configured to fold ramp 45 away from operative contact, beneath ramp 42, and to position ramp 42 at a moderate incline. FIG. 7 is configured to place ramp 45 in operable contact with ramp 42 to provide a pair of ramps. The hinge 46 is supported in this configuration by the support 44, which props up the area of the hinge 46. In this configuration shown in FIG. 7, the ramp 45 has been pivoted outwardly so that its contact or engagement surface is accessible by a wheeled object. FIG. 8 shows module 40 configured for maximum ramp incline having ramps 42 and 45 extending upwardly at maximum inclination. In this configuration, the support 44 is folded down and is not used. Ramp 45 is engaged with a portion of the frame 41 to provide the support and stability for ramp 42. Finally, FIG. 9 shows module 40 in a fully collapsed configuration.

Referring to FIG. 6, the frame 41 of the ramp module or accessory 40 includes a coupling portion 40A on a side of the module 40. In this embodiment, the coupling portion 40A includes a cup or receiving portion 73 that defines a recess or receptacle. The coupling portion 40A also includes a coupler 74 engaged with the recess and having a projecting portion extending outward from the module 40. The projecting portion can be inserted into a recess formed in a coupling portion of a different module to couple the modules together.

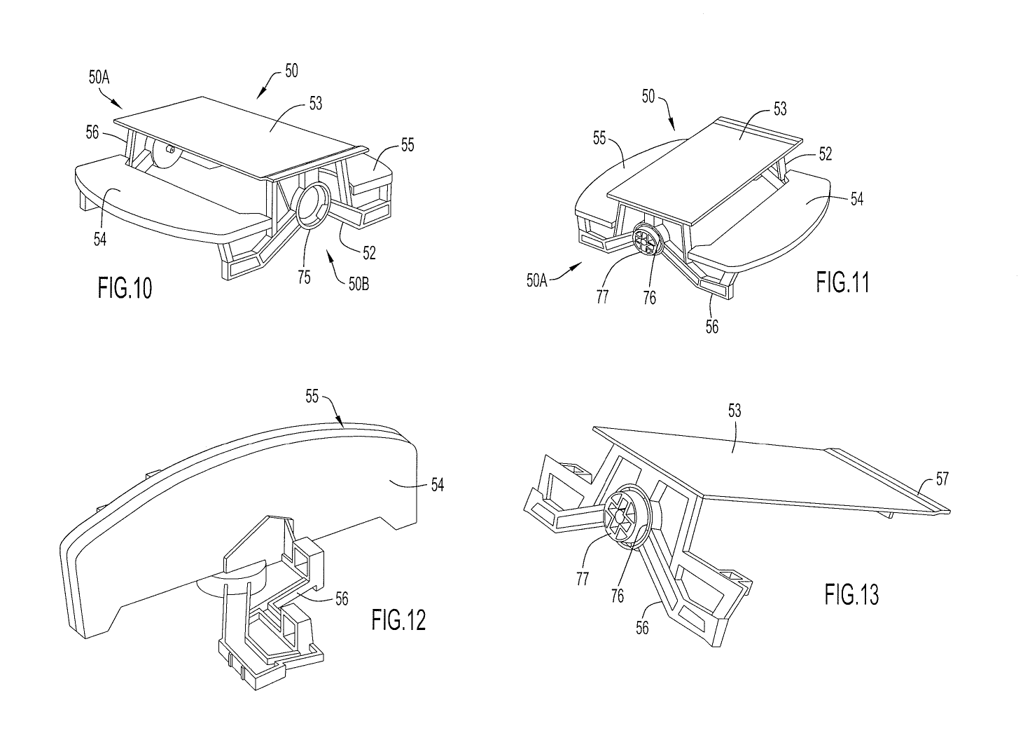

FIGS. 10, 11, 12 and 13 show picnic table module 50 in various configurations, all in perspective view. Thus, with simultaneous reference to FIGS. 10 through 13, picnic table module 50 includes a pair of frames 52 and 56 having seats 54 and 55 and table top 53 extending therebetween. The module 50 includes coupling portions 50A and 50B formed at opposite ends of the module 50. In this embodiment, for coupling portion 50B, frame 52 defines or supports a connector cup 75, and for coupling portion 50A, frame 56 supports or defines a connector cup 76. Each of the cups 75 and 76 forms a receiving portion that defines a recess or receptacle. As shown, a coupler 77 is received within cup 76. A portion of the coupler 77 projects from the frame of the module 50 and can be referred to as a projecting portion.

FIGS. 10 and 11 show opposite side perspective views of module 50 in its picnic table configuration. FIG. 12 shows module 50 in a collapsed configuration in which frames 52 and 56 support seats 54 and 55 in a vertical orientation to provide a rail. Finally, FIG. 13 shows module 50 configured to provide a ramp in which frame 56 supports one end of table top 53 to form a ramp. At the lower end of tabletop 53, a plate 57 is secured.

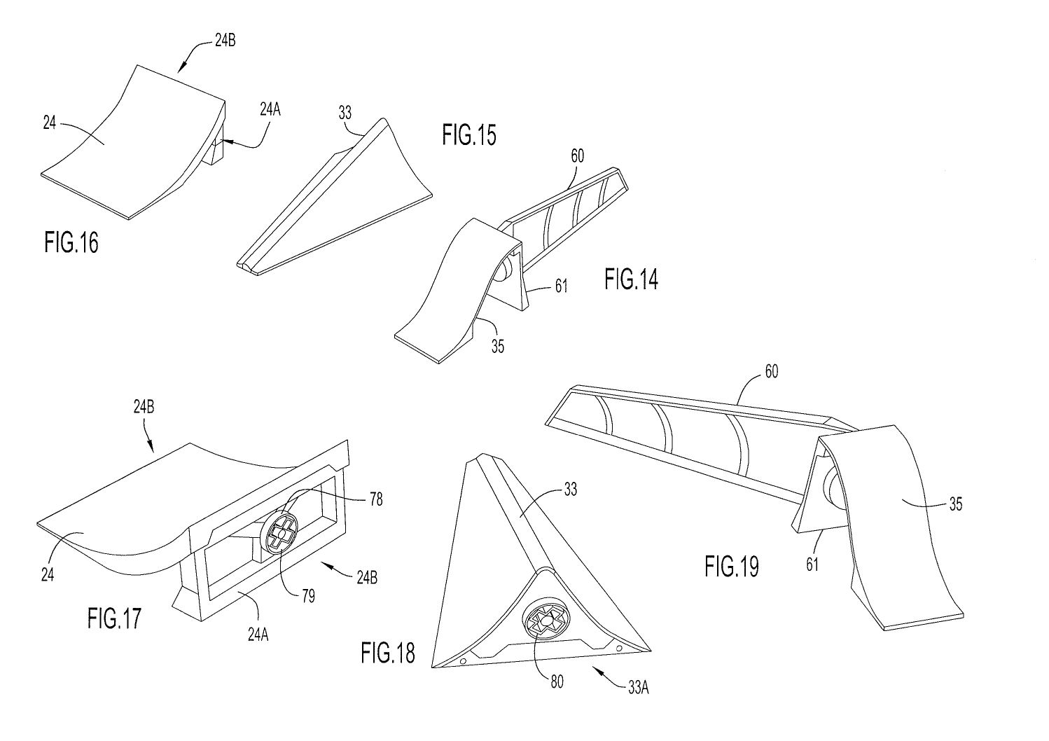

FIGS. 16 through 19 show various perspective views of further modules utilized in the present invention system. FIGS. 15 and 18 show dual curved ramp module 33, FIGS. 14 and 19 show rail module 60 with a curved ramp 35, and FIGS. 16 and 17 show front and rear perspective views of a curved ramp module 24B formed by frame 24A and curved ramp 24. Each of the modules 24B, 33, and 60 includes a coupling portion that enables the particular module to be coupled to a different module. As shown in FIG. 17, curved ramp module 24B includes a coupling portion that includes a receiving portion or cup 78 and a projecting portion 79, such as a coupler. Referring to FIG. 18, the coupling portion 33A of module 33 includes a projecting portion 80 in the form of a coupler that can be engaged with a receiving portion or recess on a different module.

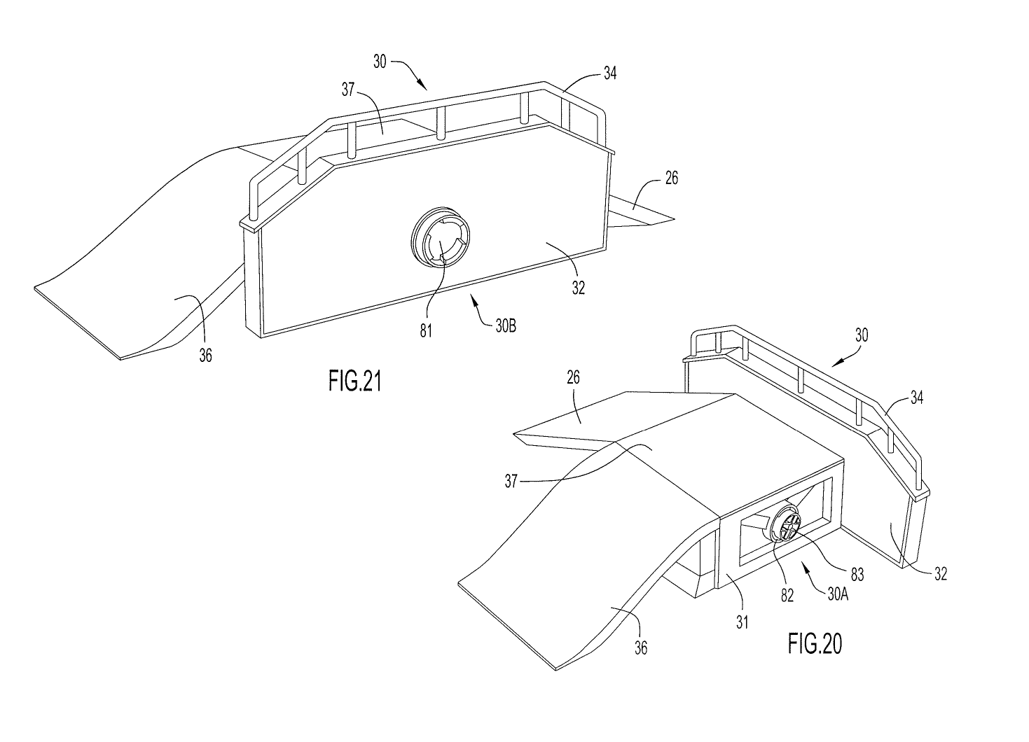

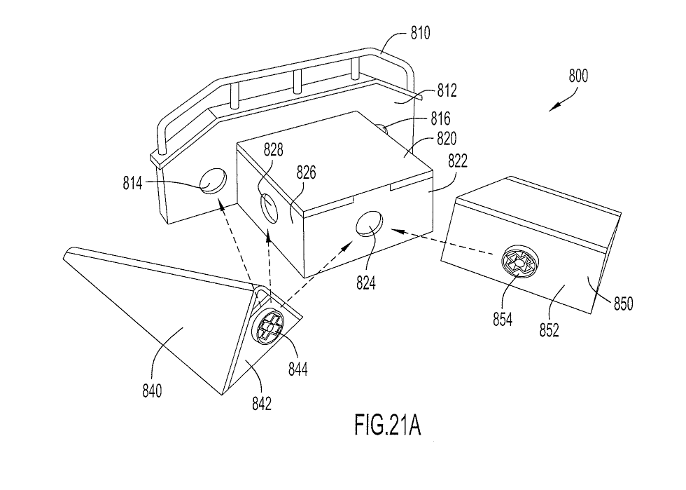

FIGS. 20 and 21 show perspective views of rail module 30. With concurrent reference to FIGS. 20 and 21, module 30 includes a side frame 32 supporting a rail 34. A base 31 is joined to the side frame 32 and supports a platform 37 together with ramps 26 and 36. As shown in FIG. 20, the ramp or accessory 36 can be placed in a first orientation relative to base 31 and engaged with the base 31. The ramp 36 can be decoupled from the base 31 and engaged with a different portion or side of the base 31 as shown in FIG. 21. The different configurations in which the ramp 36 and the base 31 can be placed results from multiple coupling portions on the base 31.

Referring to FIG. 20, the base 31 includes a coupling portion 30A that includes a receiving portion or receptacle or connector cup 82 with a coupler or projecting portion 83 extending therefrom. The ramp 36 includes its own coupling portion that includes a receiving portion or recess that can receive the projecting portion 83 of the coupler. Referring to FIG. 21, the side frame 32 includes a coupling portion 30B that includes a connector cup or receiving portion 81 supported by the side frame 32.

Referring to FIG. 21A, an alternative embodiment of a system according to the invention is illustrated. In this embodiment, the system or assembly 800 includes an engagement accessory or structure 810 with a housing 820 coupled thereto. The structure 810 has a wall 812 that includes recesses or receiving portions 814 and 816 formed therein. The housing 820 includes side walls 822 and 826 that have recesses 824 and 828 formed therein, respectively.

A ramp structure or module 840 with several surfaces includes a wall 842 from which a coupling portion including coupler 844 projects. The coupler 844 is formed separately from the wall 842 and is inserted into a recess (not shown) in the wall 842. As indicated by the arrows in FIG. 21A, the coupler 844 can be engaged with any of the recesses 814, 816, 824, and 828. Similarly, another ramp structure or module 850 with a wall 852 having a coupling portion with coupler 854 extending therefrom can be coupled to the engagement accessory 810. The coupler 854 can be engaged with any of the recesses 814, 816, 824, and 828 to provide a ramp structure for use with a wheeled object. The multiple recesses provide for several different arrangements of the components to keep the ramp structures varying and interesting. The coupling portions of the modules are engaged with each other by moving the accessories laterally toward each other so that the coupler of one accessory engages or snaps into the recess of another accessory.

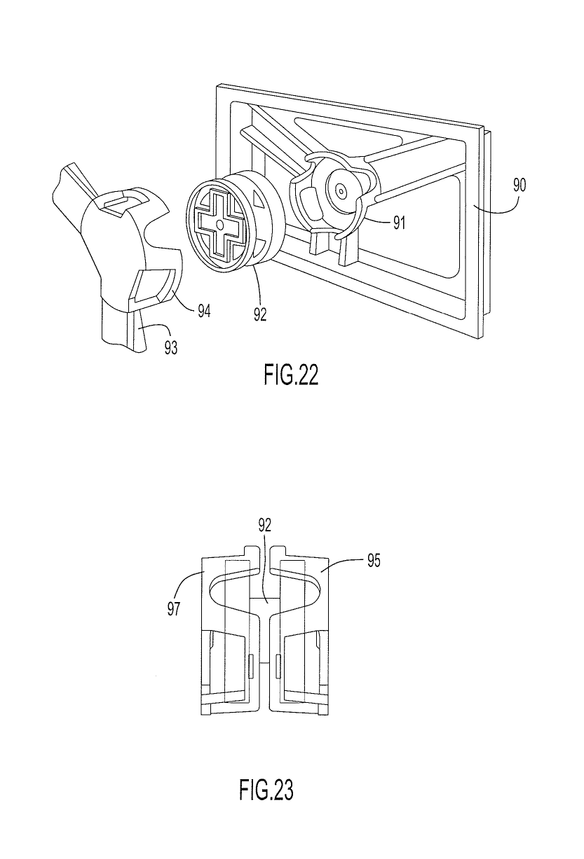

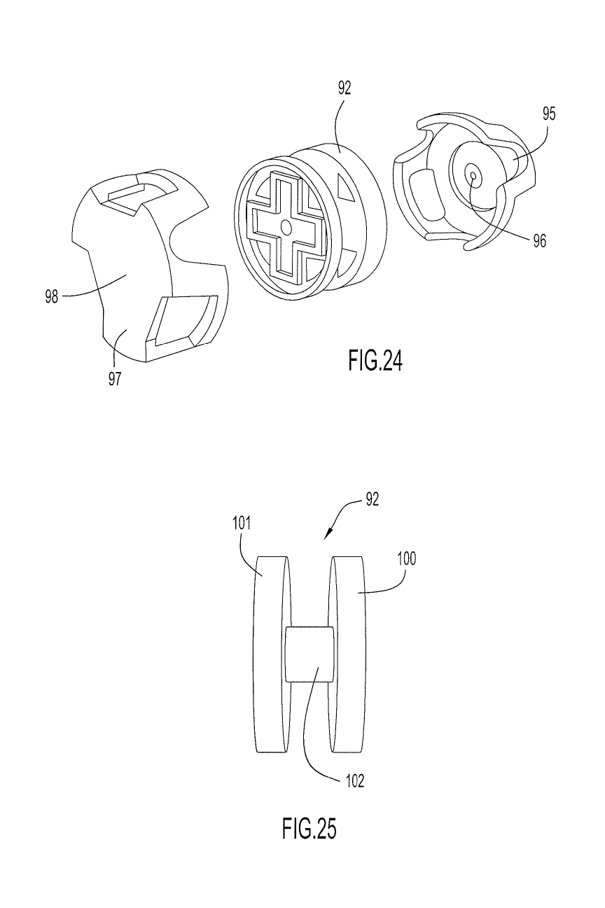

FIG. 22 sets forth a perspective assembly view of a molded in connector apparatus in which a frame 90 includes a molded in connector cup 91 defining a receiving portion while a frame 93 includes a molded in connector cup 94 defining a receiving portion. A coupler 92 (also shown in FIG. 25) is received within receiving portions or connector cups 91 and 94 to join frames 90 and 93 when the frames 90 and 93 are moved laterally toward one another.

FIGS. 23 and 24 set forth an additional connector configuration in which receiving portions or cups 95 and 97 are formed separately from the modules or their bases and may be secured to various play environment elements by fasteners passed through apertures 96 and 98 in the receiving portions 95 and 97. A coupler 92 is interposed or placed between cups 95 and 97 to provide a connection between the receiving portions. FIG. 25 shows coupler 92 in side elevation view having disk portions 100 and 101 joined in a spaced apart relationship by a center hub 102. The coupler 92 is sized so that one of the disk portions 100 and 101 extends outwardly when the coupler 92 is inserted or mounted into a receiving portion while the other disk portion remains engaged with the receiving portion to which the coupler 92 is coupled.

The lateral movement of the accessories relative to each other is due to the particular configuration of the coupling portions of the accessories. As described above, when two accessories are to be coupled together, the coupling portion of one accessory includes a projecting portion that extends outward laterally from the accessory and the coupling portion of the other accessory includes a receiving portion or recess. Thus, the orientations of the projecting portion and the receiving portion require that one or both of the accessories be moved in laterally relative to each other.

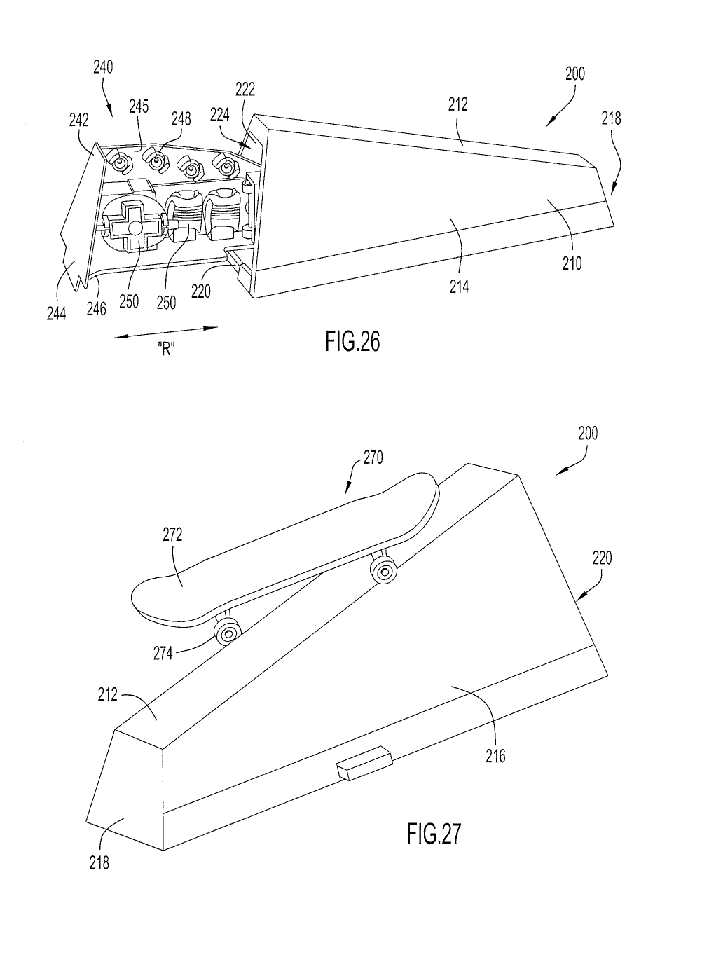

Referring to FIGS. 26-27, an alternative embodiment of an engagement accessory is illustrated. In this embodiment, the engagement accessory 200 includes a housing 210 with several surfaces 212, 214, and 216 that extend between ends 218 and 220 of the housing 210. As shown, the housing 210 has a tapered configuration in which the height of the housing 210 at end 220 is greater than the height of the housing 210 at end 218. The surfaces 212, 214, and 216 are separated by edges that extend between the ends 218 and 220. Housing 210 includes an opening 222 proximate to end 220 that provides access to an internal receptacle or chamber 224. The housing 210 can be made of molded plastic.

An exemplary wheeled object 270, such as a miniature skateboard, includes a board or base portion 272 with several wheels 274 coupled thereto. The wheeled object 270 can be manipulated by a user to engage one or more of the surfaces 212, 214, or 216, or the surfaces of the ends 218 or 220.

As shown in FIG. 26, a rack 240 is movable relative to the housing 210 and insertable into the chamber 224. The rack 240 can be slid along the directions of arrow “R” into and out of the chamber 224. The rack 240 has an outer end 242 that has a plate 244 coupled thereto. The rack 240 also includes a base portion 246 to which a wall 245 is coupled. The wall 245 includes several mounts 248, such as resilient fingers or stand-off structures with slots, to which various accessories 250 can be coupled.

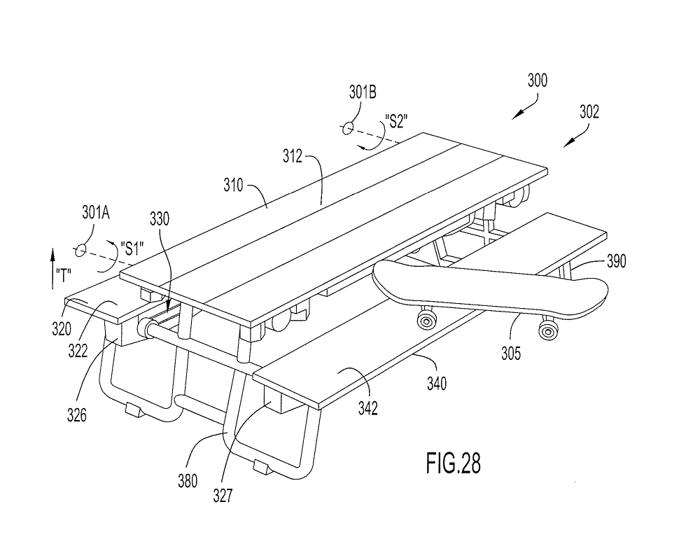

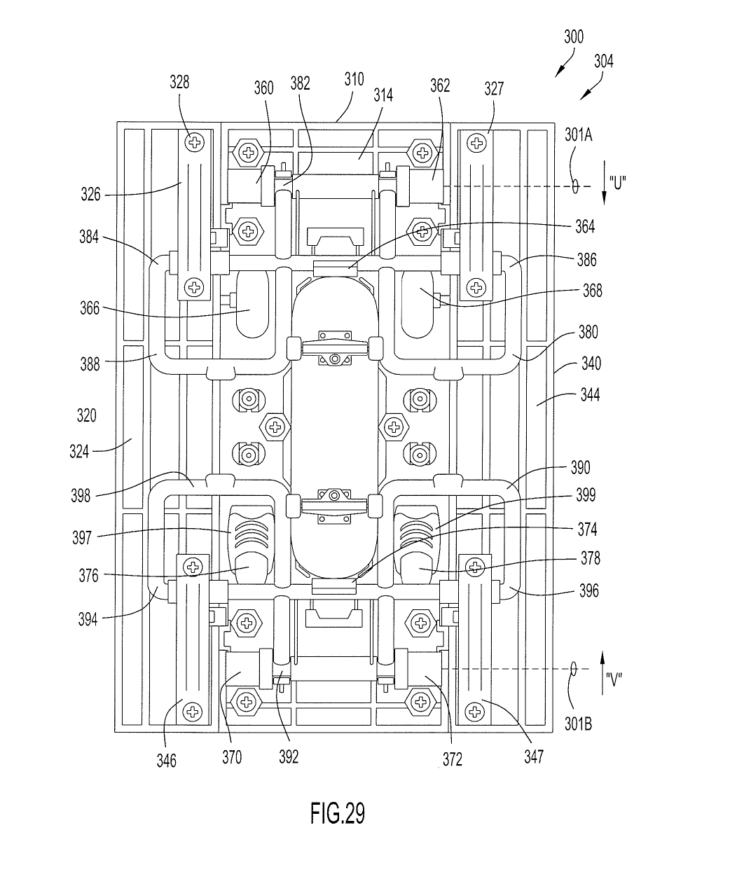

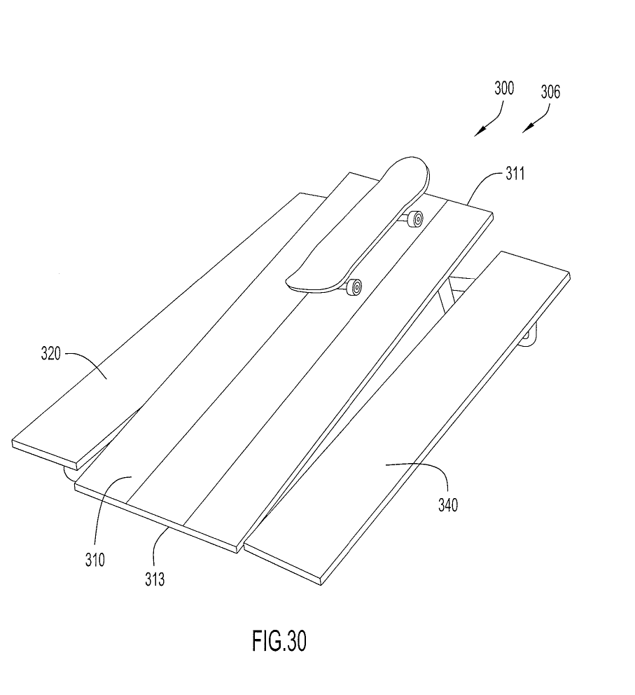

Referring to FIGS. 28-30, an alternative embodiment of an engagement accessory or structure is illustrated. In this embodiment, the engagement accessory 300 resembles a picnic table or bench. The engagement accessory 300 is placeable in multiple configurations, including a deployed configuration 302 (see FIG. 28), a collapsed configuration 304 (see FIG. 29), and a partially deployed configuration 306 (see FIG. 30). A wheeled object 305, such as a miniature skateboard, can be engaged with the various surfaces and edges of the accessory 300.

Referring to FIG. 28, the accessory 300 includes a top or top portion 310, benches or seats 320 and 340, and legs 380 and 390. The top portion 310 has an upper surface 312 and the benches 320 and 340 have upper surfaces 322 and 342, respectively. The legs 380 and 390 are configured to be placed in contact with a support surface or object to support the accessory 300. Leg 380 is pivotally coupled to the top 310 and slidably coupled to the benches 320 and 340. Similarly, leg 390 is pivotally coupled to the top 310 and slidably coupled to the benches 320 and 340. As a result, the benches 320 and 340 can be moved from their deployed positions shown in FIG. 28 to their collapsed positions shown in FIG. 29. In their collapsed positions, the benches 320 and 340 are proximate to the top 310 and, in this embodiment, the benches 320 and 340 are substantially in the same plane as the top 310 when collapsed.

Referring back to FIG. 28, leg 380 is pivotable about an axis 301A along the direction of “S1” from its deployed position to its collapsed position. Similarly, leg 390 is pivotable about an axis 301B along the direction of “S2” from its deployed position to its collapsed position. As one or both of the legs 380 and 390 are pivoted, the benches 320 and 340 can be moved along the direction of arrow “T” in FIG. 28.

Referring to FIG. 29, the accessory 300 is in its collapsed configuration. In this configuration, the legs 380 and 390 have been pivoted to be proximate to the lower surface 314 of the top 310 and the lower surfaces 324 and 344 of the benches 320 and 340, respectively. Coupled to the lower surface 314 of the top 310 are pairs of mounts or mounting structures 360 and 362, and 370 and 372, which are part of a component that is attached to the lower surface 314. Each of the mounts 360, 362, 370, and 372 includes an opening or recess into which a projecting portion from one of the legs 380 and 390 is inserted. As shown, end 382 of the leg 380 includes projecting portions that are inserted into and pivotally supported by the mounts 360 and 362. Similarly, end 392 of the leg 390 includes projecting portions that are inserted into and pivotally supported by the mounts 370 and 372.

Coupled to the lower surface 314 of the top 310 are guides or rails 326, 327, 346, and 347 via connectors 328, such as screws. Each of the guides or rails 326, 327, 346, and 347 includes a slot 330 (see FIG. 28) in which a sliding or moving portion of one of the legs 380 or 390 is inserted. As shown in FIG. 29, leg 380 has moving portions 384 and 386 that are engaged with and slide along guides 326 and 327. Similarly, leg 390 has moving portions 394 and 396 that are engaged with and slide along guides 346 and 347. As the ends 382 and 392 of the legs 380 and 390 pivot about axes 301A and 301B, portions 384, 386, 394, and 396 slide along the directions of arrows “U” and “V” along the slots in the guides 326, 327, 346, and 347, thereby permitting the benches 320 and 340 to move relative to the top 310 to their collapsed positions as shown in FIG. 29. The legs 380 and 390 are retained in their collapsed positions by latches 364 and 374, each of which is a resilient finger that has a tip or lip that engages one of the legs 380 and 390 to retain them in position. To deploy the accessory 300, the legs 380 and 390 can be pivoted in the opposite directions and moved to their deployed positions with engaging portions 388 and 398 contacting a support surface.

In this embodiment, various small accessories, such as caps 397 and 399 can be mounted to the underside of the accessory 300 on tabs 376 and 378 as shown, or tabs 366 and 368.

Referring to FIG. 30, a partially deployed configuration of the accessory 300 is illustrated. In this configuration 306, the leg proximate to end 311 of the top 310 is rotated slightly and the leg proximate to end 313 of the top is not rotated. As a result, the top 310 can be inclined from end 311 toward end 313 as shown, thereby creating a ramp-like structure using accessory 300.

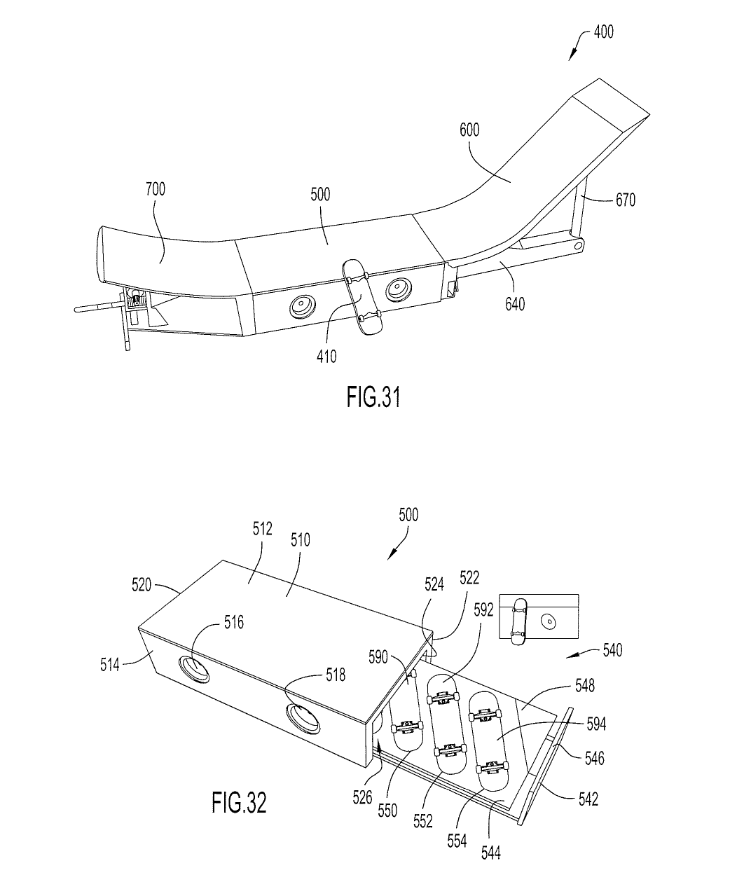

Referring to FIG. 31, an embodiment of a system or accessory is illustrated. In this embodiment, the system 400 includes a body or main portion 500, a ramp assembly 600, and a ramp assembly 700. A wheeled object 410, such as a miniature skateboard, can be used with the system 400. As described in detail below, ramp assembly 600 can be adjusted relative to portion 500 and can be used as a “drop in” or “lead in” ramp for the object 410. A user can place the object 410 on the ramp assembly 600 and move the object 410 down the ramp assembly 600 to portion 500. Ramp assembly 700 can be adjusted relative to portion 500 so that the object 410 can be launched therefrom at different trajectories.

Referring to FIG. 32, main portion 500 includes a housing 510 with an upper surface 512, opposite side walls (only side wall 514 is shown), and opposite ends 520, 522. In this embodiment, end 522 includes an opening 524 formed therein that is in communication with a chamber 526. The housing 510 includes a coupling portion with several recesses in which a coupler can be inserted to couple the housing 510 to another engagement accessory, such as ramp assembly 500 or ramp assembly 600. For example, side wall 514 includes recesses 516 and 518 as shown in FIG. 32.

The main portion 500 includes a storage component 540 that has a tray 542 that is slidable into and out of the chamber 526. The tray 542 has a base 544 and an end plate 546 coupled to the base 544. In one embodiment, the base 544 can be positioned on and slid along one or more rails or tracks or the bottom surface of the chamber 526.

As shown, the tray 542 includes a mounting plate 548 coupled thereto. The mounting plate 548 includes several recesses 550, 552, and 554 formed therein in which wheeled objects 590, 592, and 594, respectively, are inserted. The mounting plate 548 is oriented at an angle as shown so that the objects 590, 582, and 594 can be stored and displayed when the tray 540 is moved outward. The tray 540 can be slid into the housing 510 to store the objects 590, 592, and 594 and provide easy access to them when desired.

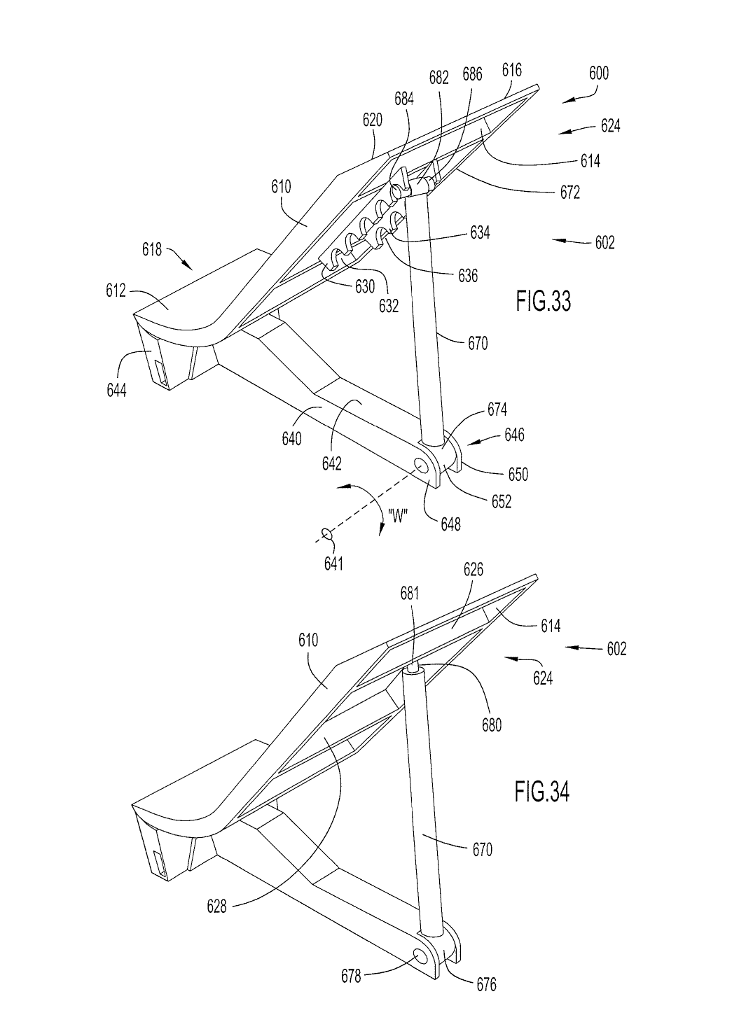

Referring to FIG. 33, an embodiment of a ramp assembly according to the invention is illustrated. In this embodiment, the ramp assembly 600 includes a ramp portion 610 that has an upper surface 612 and a lower surface 614. The ramp portion 610 is pivotally coupled to an end wall 644 that can be coupled to the housing 510 by a coupling portion that includes a coupler. The ramp portion 610 includes an end 618 and an opposite end 616 that has a tapered portion 620.

The ramp portion 610 can be maintained in a raised position 602 relative to a support surface via a support 640 and support rod 670 as shown. The support 640 rests on the support surface and includes an upper surface 642 that can be used with wheeled objects in different configurations, as described below.

The support rod 670 is pivotally coupled to the support 640 and can be rotated about an axis 641 along the directions of arrow “W” as shown in FIG. 33. Proximate to its end 646, the support 640 has plates 648 and 650 that define a space 652 therebetween. The lower end 674 of the support rod 670 has a mounting portion 676 that is inserted into the space 652 and connected to plates 648 and 650 by a connector 678 (see FIG. 34).

Referring back to FIG. 33, the support rod 670 can contact and engage an engagement portion 624 located on the lower surface 614 of the ramp portion 610. In this embodiment, the engagement portion 624 includes a pair of rails 630 and 634 that have notches 632 and 636 formed therein, respectively. The rails 630 and 634 can be integrally formed with the ramp portion 610 or formed separately and subsequently coupled thereto. Proximate to end 672 of the support rod 670 is an engagement member 682. The angle of the surface 612 and ramp portion 610 generally can be adjusted and maintained by inserting the engagement member 682 into one or more notches 632 and 636. The engagement member 682 includes projecting ends 684 and 686 that can be inserted into corresponding aligned notches 632 and 636. Thus, the desired angle can be achieved by selecting the particular pair of notches on the rails.

Referring to FIG. 34, an alternative engagement member 680 on the end of the support rod 670 is illustrated. In this embodiment, the lower surface 614 of the ramp portion 610 includes lateral ridges or walls 626 and 628 that form abutment surfaces for a projecting portion 681 of engagement member 680. Thus, the angle of the ramp portion 610 can be adjusted by engaging the projecting portion 681 with either of the walls 626 and 628.

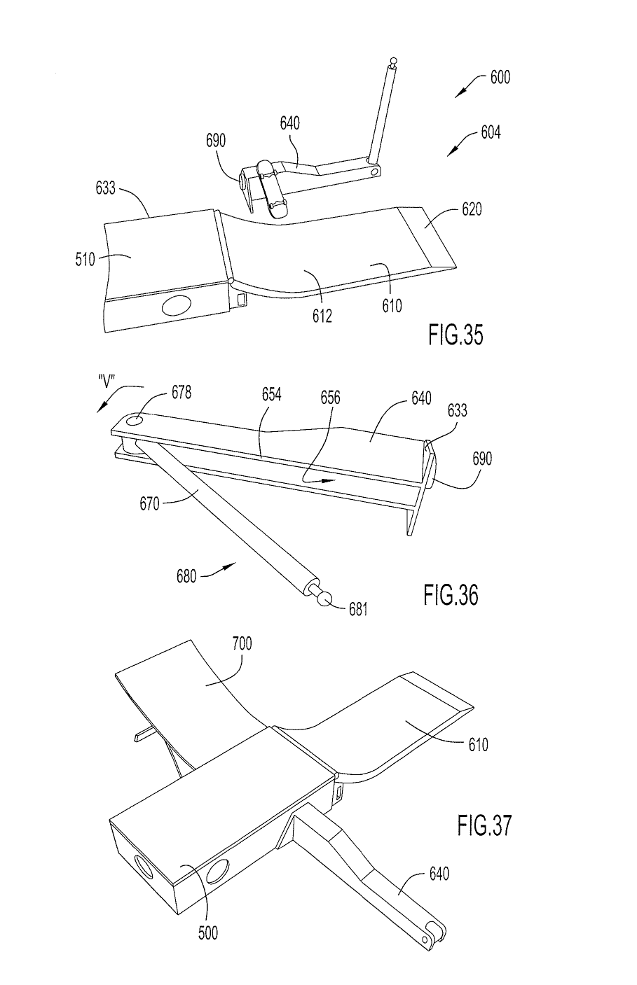

Referring to FIGS. 35 and 36, the support 640 can be decoupled from the ramp portion 610 and used separately. As shown, a coupler 690 can extend from an end wall 633 of the support 640. The coupler 690 can be removably insertable into a recess (not shown) formed in the end wall 633. In one arrangement, the coupler 690 can engage a recess formed on the housing 510 of the main portion 500 to couple the support 640 to the housing 510. In FIG. 35, when the support 640 is removed, the ramp portion 610 can be lowered so that the tapered surface 620 is proximate to the support surface. In this lowered position 604, a wheeled object can be rolled from the support surface onto the tapered surface 620, the upper engagement or contact surface 612, and then the surface of the housing 510.

Referring to FIG. 36, the support 640 has a lower surface 654 that is formed by two walls that define a chamber or receptacle 656 therebetween. As discussed above, the support rod 670 is pivotally coupled to the support 640 and rotatable around connector 678 along the direction of arrow “V.” The receptacle 656 is configured to receive the support rod 670 therein to store the support rod 670 and facilitate play using the support 640 because the rod 670 is stored. In FIG. 36, an exemplary projecting portion 681 can be seen in detail and in this embodiment, may include an enlarged end portion.

Referring to FIG. 37, the ramp portion 610 can be used with the main portion 500 in a lowered position and the support 640 used separately as a structure for the wheeled object. Also coupleable to the main portion 500 at different locations and on different sides is ramp assembly 700, which is repositionable, as described below. Consistent with the discussion above, each of the main portion 500, the ramp portion 610, the support 640, and the ramp assembly 700 includes a coupling portion that can be engaged with or by the coupling portion of another component of the system. Each of the coupling portions includes a recess or receiving portion and/or a coupler or projecting portion that are configured and oriented so that the lateral movement of the components brings the accessories or modules together and into operable engagement.

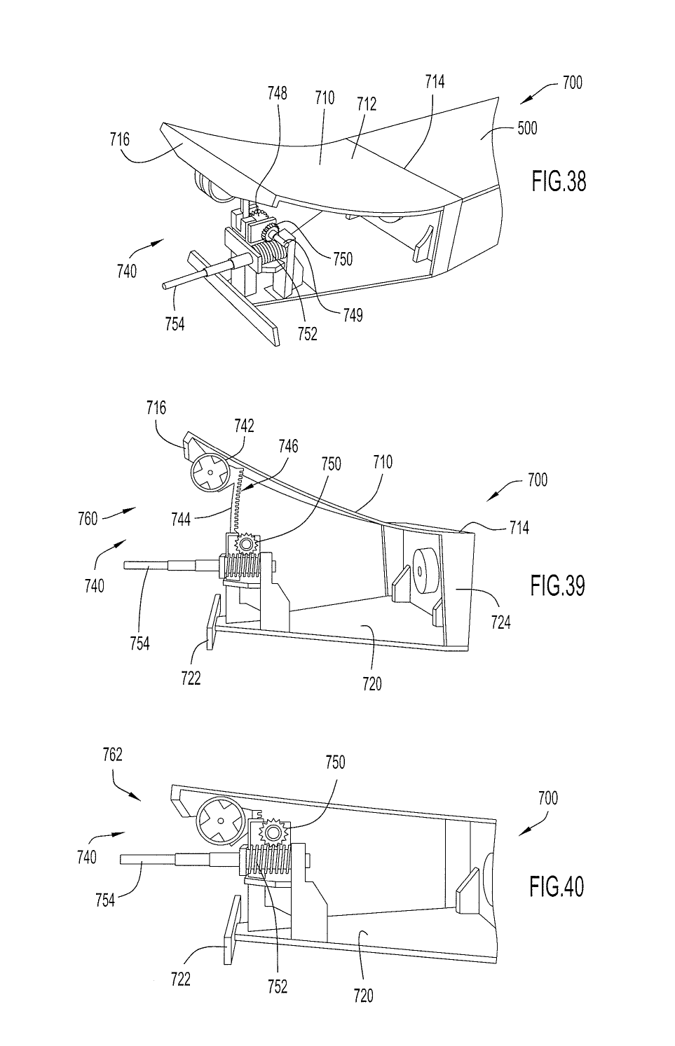

Referring to FIGS. 38-40, another embodiment of a ramp assembly is illustrated. In this embodiment, the ramp assembly 700 includes a ramp portion 710 with an upper contact or engagement surface 712 and ends 714 and 716. As shown in FIG. 39, the ramp portion 710 is coupled to a base portion that has two end walls 722 and 724 that engage a support surface.

The ramp assembly 700 includes an adjustment mechanism 740 that can be manipulated by a user to adjust the curvature of the ramp portion or plate 710. The adjustment mechanism 740 includes an actuator 754 that can be turned by a user. Alternatively, the actuator 754 can be connected to a separate component, such as a drive mechanism, that moves the actuator 754. Directly connected to the actuator 754 is a worm gear 752 with teeth that are engaged by teeth on gear 750. Gear 750 is operably coupled to axle 749 (see FIG. 39) to which another gear 748 is mounted. Gear 748 includes teeth that are engaged with the teeth 746 on rack 744 which is coupled to the lower surface of the ramp portion 710 via a coupler 742. Thus, as the actuator 754 is manipulated to rotate the worm gear 752, the rack 744 moves and the curvature of the ramp portion 710 changes between a raised position 760 (see FIG. 39) and a lowered position 762 (see FIG. 40).

What has been shown is a novel module fingerboard play environment in which the environment is formable into a number of different configurations to provide a variety of play. The modules are interconnectable by a connector having opposed connector cups which mutually receive a coupler therebetween for attachment. The play environment modules utilize composite material molded to the desired shapes to provide most of the rolling surfaces for the play environment.

As shown in the Figures and described above, an accessory can be placed in an orientation and then another accessory can be placed in an orientation and moved laterally into engagement with the other accessory. When the user wants to reconfigure the arrangement of the two accessories, one accessory is decoupled from the other accessory and moved and placed in a different orientation and then the accessories are coupled together again.

It is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points or portions of reference and do not limit the present invention to any particular orientation or configuration. Further, terms such as “first,” “second,” “third,” etc., merely identify one of a number of portions, components and/or points of reference as disclosed herein, and do not limit the present invention to any particular configuration or orientation.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. A reconfigurable assembly for use with a miniature wheeled object, comprising:
a first accessory with at least one contact surface for engagement by the wheeled object, the first accessory including a side portion with a coupling portion; and
a second accessory with at least one contact surface for engagement by the wheeled object, the second accessory including a side portion with a coupling portion, the coupling portion of the second accessory being engageable with the coupling portion of the first accessory by movement of the second accessory toward the first accessory in a lateral direction.

2. The reconfigurable assembly of claim 1, wherein the side portion of the first accessory is a first side portion and the first accessory includes a second side portion, the coupling portion of the first accessory is a first coupling portion, and the first accessory includes a second coupling portion, the first coupling portion being located along part of the first side portion and the second coupling portion being located along part of the second side portion.

3. The reconfigurable assembly of claim 2, wherein the coupling portion of the second accessory can be coupled to either of the first coupling portion or the second coupling portion of the first accessory by lateral movement of the second accessory toward and into engagement with the first accessory.

4. The reconfigurable assembly of claim 1, wherein the coupling portion of the second accessory includes a coupler removably coupleable with the second accessory, the coupler being engageable with the coupling portion of the first accessory.

5. The reconfigurable assembly of claim 4, wherein the coupling portion of the first accessory includes a recess and the coupling portion of the second accessory includes a recess, each of the recesses receiving part of the coupler when the coupler is engaged with the coupling portion of the first accessory and the coupling portion of the second accessory.

6. The reconfigurable assembly of claim 5, wherein the coupler includes a first portion that is laterally insertable into the recess of the coupling portion of the first accessory and a second portion that is laterally insertable into the recess of the coupling portion of the second accessory.

7. The reconfigurable assembly of claim 6, wherein one contact surface of the first accessory can be positioned proximate to one contact surface of the second accessory when the coupler is engaged with the first accessory and the second accessory.

8. The reconfigurable assembly of claim 1, wherein one contact surface of the first accessory and one contact surface of the second accessory form a continuous surface when the first accessory and the second accessory are coupled together.

9. The reconfigurable assembly of claim 1, wherein the second accessory is reconfigurable so that the angle of one contact surface of the second accessory relative to a support surface on which the first accessory can be placed can vary.

10. A method of assembling a reconfigurable system for use with a wheeled object, the method comprising the steps of:
disposing a first accessory in a first orientation, the first accessory having an engagement surface that can be engaged by the wheeled object, the first accessory including a coupling portion;
disposing a second accessory in a second orientation, the second accessory having an engagement surface that can be engaged by the wheeled object, the second accessory including a coupling portion; and
moving the second accessory laterally toward and into engagement with the first accessory, the movement of the second accessory resulting in the engagement of the coupling portion on the second accessory with the coupling portion of the first accessory.

11. The method of claim 10, wherein the coupling portion of the second accessory includes a recess and the coupling portion of the first accessory includes a recess, and the method further comprises:
inserting a coupler into the recess of the coupling portion of the second accessory.

12. The method of claim 11, wherein the moving a second accessory includes engaging the coupler with the recess of the first accessory.

13. The method of claim 11, wherein the coupling portion of the first accessory is a first coupling portion and the first accessory includes a second coupling portion, the method further comprises:
decoupling the second accessory from the first accessory;
moving the second accessory from its second orientation to a third orientation relative to the first accessory, the third orientation being different from the second orientation; and
moving the second accessory laterally into engagement with the first accessory so that the second accessory is maintained in the third orientation relative to the first accessory, the movement resulting in engagement of the coupling portion of the second accessory with the second coupling portion of the first accessory.

14. A reconfigurable assembly for use with a wheeled object, the assembly comprising:
a first engagement accessory having a surface along which the wheeled object can travel, the first engagement accessory having a coupling mechanism with a receiving portion; and
a second engagement accessory having a surface along which the wheeled object can travel, the second engagement accessory having a coupling mechanism with a projecting portion that engages the receiving portion when the second engagement accessory is moved laterally toward and into engagement with the first engagement accessory.

15. The reconfigurable assembly of claim 14, wherein the second engagement accessory has a body, the coupling mechanism of the second engagement accessory includes a recess formed in the body and a removable coupler that can be inserted into the recess of the body, and the coupler includes the projecting portion.

16. The reconfigurable assembly of claim 15, wherein the coupler is laterally insertable into the recess on the body of the second engagement accessory.

17. The reconfigurable assembly of claim 15, wherein the first engagement accessory has a body that includes a first side with a first recess and a second side with a second recess, each recess being configured to receive the projecting portion of the coupler.

18. The reconfigurable assembly of claim 15, wherein the surface of the first engagement accessory can be positioned proximate to the surface of the second engagement accessory when the coupler is engaged with the first engagement accessory and the second engagement accessory.

19. The reconfigurable assembly of claim 14, wherein the surface of the first engagement accessory and the surface of the second engagement accessory form a continuous surface when the first engagement accessory is coupled to the second engagement accessory.

20. The reconfigurable assembly of claim 14, wherein the second engagement accessory is reconfigurable so that the angle of the surface of the second engagement accessory relative to a support surface on which the second engagement accessory can be placed can vary.
